(19) United States
(12) Patent Application Publication
(10) Pub. No.: US 2023/0042052 A1
(43) Pub. Date: Feb. 9, 2023

(54) ELECTROSTATIC SPRAY DRIED MILK PRODUCT AND PRODUCTION METHOD THEREOF

(71) Applicant: Spraying Systems Co., Wheaton, IL (US)

(72) Inventors: Bogdan Zisu, Truganina (AU); AKM Masum, Truganina (AU); Juhi Saxena, Truganina (AU); Michel Thenin, Aurora, IL (US); Audrey Maudhuit, Treillieres (FR)

(21) Appl. No.: 17/776,008

(22) PCT Filed: Nov. 20, 2020
(86) PCT No.: PCT/US2020/061460

§ 371 Date: May 11, 2022

Related U.S. Application Data
(60) Provisional application No. 62/938,802, filed on Nov. 21, 2019.

(51) Int. Cl. A23C 9/16; A23C 9/20; A23C 1/05; A23C 13/12; A23C 21/00; A23C 9/123; A23L 33/00

(52) U.S. Cl. CPC A23C 9/16; A23C 9/206; A23C 1/05; A23C 13/125; A23C 21/00; A23C 9/123; A23L 33/40; A23V 2002/00

(57) ABSTRACT

Provided is an electrostatic spray dried powdered milk product with a surface composition comprising at least 8% less fat compared to a spray dried powder of the same milk product. Further provided is a method of providing a powdered milk product comprising electrostatic spray drying a milk product at an inlet temperature of below 150° C. The electrostatic spray dried milk product powder has a surface composition with a reduced fat content and increased carbohydrate content relative to the same milk product powder prepared by high heat spray drying.

### CROSS-REFERENCE TO A RELATED APPLICATION

This patent application claims the benefit of U.S. Provisional Patent Application No. 62/938,802, filed Nov. 21, 2019, which is incorporated by reference.

### BACKGROUND OF THE INVENTION

Powdered milk is made by evaporating milk to dryness. The powdered milk can then be used in powder form for various foods, such as baked goods, or reconstituted for drinking, including infant formula. As such, milk powder is an important commodity used globally.

Drying of milk products typically is achieved using a spray drying system. However, such systems require high inlet and outlet temperatures, which risk degrading the milk powder product. Thus, there remains a need to effectively provide a powdered milk product that is shelf stable, can be reconstituted readily, and retains a desirable appearance (e.g., reduced coloring) and/or taste.

### BRIEF SUMMARY OF THE INVENTION

The invention provides an electrostatic spray dried powdered milk product with a surface composition comprising at least 8% less fat compared to a spray dried powder of the same milk product.

The invention further provides a method of providing a powdered milk product comprising electrostatic spray drying a milk product at an inlet temperature of below 150° C.

### BRIEF DESCRIPTION OF THE SEVERAL VIEWS OF THE DRAWINGS

FIG. 1 is a vertical section of an illustrated spray drying system for processing milk products into powder form according to an embodiment of the invention.

FIG. 2 is an enlarged vertical section of the electrostatic spray nozzle assembly of the illustrated spray drying system.

FIG. 3 shows electrostatically agglomerated whole milk powder in macro-(FIG. 3A) and micro-form (FIG. 3B).

FIGS. 4A-4D are scanning electron microscope images of whole milk powders. FIGS. 4A and 4C are spray dried powders at 180° C. inlet temperature and 90° C. outlet temperature at 500× magnification (FIG. 4A) and 5000× magnification (FIG. 4C). FIGS. 4B and 4D are electrostatic spray dried powders at 90° C. inlet temperature, 35° C. atomizing temperature, and 5 kV electrostatic charge at 500× magnification (FIG. 4B) and 5000× magnification (FIG. 4D).

FIGS. 5A-5F are scanning electron microscope images of colostrum powders. FIGS. 5A, 5C, and 5E are electrostatic spray dried powders at 90° C. inlet temperature and 30° C. atomizing temperature at 500× magnification (FIG. 5A), 2000× magnification (FIG. 5C), and 5000× magnification (FIG. 5E). FIGS. 5B, 5D, and 5F are electrostatic spray dried powders at 150° C. inlet temperature and 80° C. atomizing temperature at 500× magnification (FIG. 5B), 2000× magnification (FIG. 5D), and 5000× magnification (FIG. 5F).

FIG. 6 is a bar graph of the lactoferrin content (mg/g) in electrostatic spray dried colostrum powders dried at 90° C. inlet/30° C. exhaust and 150° C. inlet/60° C. exhaust.

FIG. 7 is a bar graph of the IgG content (mg/g) in electrostatic spray dried colostrum powders dried at 90° C. inlet/30° C. exhaust and 150° C. inlet/60° C. exhaust.

FIGS. 8A-8L are scanning electron microscope images of lactoferrin powders. FIGS. 8A, 8B, and 8C are electrostatic spray dried powders at a negative charge at 500× magnification (FIG. 8A), 5000× magnification (FIG. 8B), and 10,000× magnification (FIG. 8C). FIGS. 8D, 8E, and 8F are electrostatic spray dried powders at a positive charge at 500× magnification (FIG. 8D), 5000× magnification (FIG. 8E), and 10,000× magnification (FIG. 8F). FIGS. 8G, 8H, and 8I are spray dried powders without an electrostatic charge at 500× magnification (FIG. 8G), 5000× magnification (FIG. 8H), and 10,000× magnification (FIG. 8I). FIGS. 8J, 8K, and 8L are freeze dried powders at 500× magnification (FIG. 8J), 2000× magnification (FIG. 8K), and 5000× magnification (FIG. 8L).

FIG. 9 is a bar graph of the active lactoferrin content (mg/mL) in lactoferrin powders dried at 150° C. inlet with and without electrostatic charge.

FIGS. 10A-10D are scanning electron microscope images of whey protein concentrate (WPC) powders. FIG. 10A is at 500× magnification. FIG. 10B is at 2000× magnification. FIG. 10C is at 5000× magnification. FIG. 10D is at 10,000× magnification.

FIGS. 11A-11B are scanning electron microscope images of 20% (w/w) yogurt powders after electrostatic spray drying at 5 kV, 95° C. inlet temperature, and 40° C. outlet temperature at 10,000× magnification.

FIGS. 12A-12B are bar graphs showing the cell counts (cfu/mL) for L. delbrueckii subsp. bulgaricus (FIG. 12A) and Streptococcus thermophilus (FIG. 12B) in 20% (w/w) yogurt fermented to pH 4.5 or pH 5.0.

FIGS. 13A-13B are bar graphs showing the cell counts (cfu/mL) for L. delbrueckii subsp. bulgaricus (FIG. 13A) and Streptococcus thermophilus (FIG. 13B) in yogurt powders (yogurt was dried from 20% (w/w) yogurt fermented to pH 4.5 or pH 5.0) immediately after manufacture and after 8 weeks of storage at 4° C.

FIGS. 14A-14E are scanning electron microscope images at 2000× magnification of an infant milk formula after electrostatic spray drying (ESD) and traditional spray drying. The images show an ESD powder dried at an inlet temperature of 90° C. and an atomizing temperature of 35° C. at either a negative charge (FIG. 14A) or a positive charge (FIG. 14B), an ESD powder dried at an inlet temperature of 150° C. and an atomizing temperature of 80° C. at either a negative charge (FIG. 14C) or a positive charge (FIG. 14D), and a spray dried powder (FIG. 14E).

FIGS. 15A-15E are scanning electron microscope images at 2000× magnification of a skim milk powder after electrostatic spray drying and traditional spray drying. The images show an ESD powder dried at an inlet temperature of 90° C. and an atomizing temperature of 35° C. at either a negative charge (FIG. 15A) or a positive charge (FIG. 15B), an ESD powder dried at an inlet temperature of 150° C. and an atomizing temperature of 80° C. at either a negative charge (FIG. 15C) or a positive charge (FIG. 15D), and a spray dried powder (FIG. 15E).

While the invention is susceptible of various modifications and alternatives, certain illustrative embodiments will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

The present invention is predicated, at least in part, on the surprising discovery that milk product powders that are spray dried using a traditional high heat spray drying system compared to a low heat, electrostatic spray system have almost identical bulk compositions but quite different surface compositions. In accordance with this discovery, the invention provides an electrostatic spray dried powdered milk product with a surface composition comprising at least 8% (e.g., at least 9% fat, at least 10% fat, at least 11% fat, at least 12% fat) less fat compared to the surface composition of a spray dried powder of the same milk product. For example, an electrostatic spray dried powdered milk product with a surface composition comprising about 70% fat has almost 10% less surface fat compared to the same milk product dried using traditional high heat spray drying.

In some embodiments, the surface composition of the electrostatic spray dried powdered milk product further comprises at least 10% (e.g., 11% or more, 12% or more) of a carbohydrate, including lactose, glucose, and/or galactose relative to the same milk product dried using traditional heat spray drying. Typically, the carbohydrate is lactose. In addition to fat and carbohydrates, the remainder of the surface composition of the dried milk powder is one or more proteins.

The powdered milk product has a low moisture content, typically about 5% or less (e.g., about 4.5% or less, about 4% or less, about 3.5% or less, about 3% or less, about 2.5% or less, about 2% or less) in combination with a low water activity (e.g., about 0.3 or less, including 0.2 or less, about 0.15 or less, about 0.1 or less).

In any of the embodiments herein, the powdered milk product is agglomerated, preferably during the drying process for forming the powdered milk product. Agglomerated particles are any size, but typically have a diameter of about 100 μm or more (e.g., 150 μm or more, 200 μm or more, 250 μm or more, 300 μm or more, 350 μm or more, 400 μm or more, 450 μm or more, or 500 μm or more). In general, the more aggregated the powder, the better the wettability. A method of forming the powdered milk product of the present invention can result in multiple aggregates of varying size (i.e., not all the agglomerates are of the same size). Each agglomerate is an assembly of one or more primary particles. The primary particles vary in size and typically have a diameter of about 10 μm or more (e.g., about 12 μm or more, about 15 μm or more, about 18 μm or more, about 20 μm or more, about 25 μm or more). Without wishing to be bound by any theory, it is believed that highly agglomerated, granular-like powders are produced during the electrostatic spray drying process, as agglomeration is induced by the electrostatic charge. In comparison, spray dried powders do not agglomerate during the drying process.

The term “milk product” refers to a product that comprises at least some portion of milk in any form. The milk product can comprise milk, butter, manufacturer's cream, heavy whipping cream, whipping cream, medium cream, light cream, half and half, buttermilk, yogurt, a nutritional formulation, colostrum, whey proteins, lactoferrin, lactoglobulin, or any combination thereof. The milk can be from any suitable female mammal source, including a human, cattle, sheep, goat, horse, donkey, camel, moose, water buffalo, yak, or reindeer. Milk from various sources can be combined, as necessary. In some preferred embodiments, the milk product comprises milk from cattle (e.g., a cow). In some embodiments, the nutritional formulation comprises infant formula, a non-infant (e.g., toddler, child, adult, elderly) nutrition formulation (e.g., PEDIASURE™ and ENSURE™ from Abbott Nutrition, Chicago, Ill.), or a sport (e.g., athlete) nutrition formulation. In some preferred embodiments, the milk product comprises infant formula.

The milk product can be used either fresh (e.g., liquid form) or in reconstituted form. For example, a milk powder can be reconstituted to liquid form and then electrostatically spray dried, as described herein, to provide a powdered milk product of the present invention. If desired, the reconstituted milk product can be further dried prior to electrostatic spray drying the milk product. Milk products in reconstituted form include, for example, a spray dried milk powder, infant formula, a non-infant nutrition powder, and a sport nutrition powder.

The milk product composition will vary depending on the source of the milk. Typically, the milk will contain varying amounts of fat, protein, and sugars (e.g., lactose, glucose, galactose), along with salts, minerals (e.g., calcium, sodium, iodine, potassium, magnesium), and/or vitamins (e.g., vitamin A, vitamin B₁₂, vitamin D, vitamin K, pantothenic acid, riboflavin, and biotin).

The milk product can have any fat content, including 0-85% (e.g., 0-80%, 0-40%, 3-38%, 3-35%, 3.25%-35%, 3-20%, 3.25-20%, 3-12%, 3.25-12%, 3-8%, 3.25-8%, 3-6%, or 3.25-6%) fat. In some embodiment, the milk product has a relatively high fat content of about 10-85% (e.g., 12-84%, 20-84%, 12-40%, 20-40%, 12-35%, or 20-35%) fat. In general, the milk product comprises a milk designated as whole (e.g., about 3-6% fat, including about 5% fat, about 3.6% fat, about 3.25% fat), reduced or low fat (e.g., 0.5-2.8% fat, 0.5-2.5% fat, 0.5-2% fat, 0.5-1.8% fat, including 0.5% fat, 1% fat, 1.5% fat, 2% fat), or skimmed (e.g., 0.5% fat or less, 0.3% fat or less, 0.15% fat or less, or 0% fat (non-fat)) milk. Preferably, the milk to be electrostatically spray dried is whole (full fat) milk with no reduction in the fat content relative to the original source.

Conventionally spray dried milk products can undesirably change color, e.g., to yellow and/or brown, from their original appearance after drying and/or storage. In an aspect of the invention, the powdered milk product retains a desirable appearance, such as reduced coloring. In particular, the powdered milk product of the present invention retains a color, such a white or off-white color, which closely resembles the color of the milk product prior to electrostatic spray drying. The reduced coloring can be measured by any suitable technique, such as the CIELAB (International Commission on Illumination L*a*b*) system and measuring the 5-hydroxymethylfurfural (HIMF) content.

In the CIELAB system, L* defines lightness, a* denotes the red/green value, and b* is the yellow/blue value. An increase in the +b* direction depicts a shift toward yellow. Thus, the b* value in an electrostatically spray dried milk product of the invention is about 12 or less (e.g., 11 or less, 10 or less, 9 or less, or 8 or less).

HMF is a cyclic aldehyde produced by sugar degradation through the Maillard reaction (a non-enzymatic browning reaction) during food processing or storage. For example, the HMF content in an electrostatically spray dried milk product of the invention is about the same as (e.g., within 20% or less, within 15% or less, within 10% or less, within 5% or less, within 2% or less, or within 1% or less) the HMF content of the milk product prior to drying. Alternatively, the HMF content in an electrostatically spray dried milk product of the invention is reduced about 1.5 times or more (e.g., about 2 times or more, about 2.5 times or more, about 3 times or more) compared to the HMF content of the same milk product that has been spray dried using traditional high heat conditions (180° C. inlet temperature, 90° C. atomizing temperature, and 300 kPa atomizing gas pressure) when measure at Day 0 or after 1 week of storage at 22° C. and 54% relative humidity (RH) or after 2 weeks of storage at 22° C. and 54% RH or after 8 weeks of storage at 22° C. and 11% RH or after 2 weeks of storage at 45° C. and 54% RH.

The powdered milk product of the present invention with the desired surface composition and/or agglomeration properties preferably is electrostatically spray dried. As a result, the present invention provides for a method of providing a powdered milk product comprising electrostatic spray drying a milk product at an inlet temperature of below 150° C. The inlet temperature is any suitable temperature that provides a milk powder product with the surface composition and/or agglomeration features described herein. For example, the inlet temperature is about 140° C. or below, about 135° C. or below, about 130° C. or below, about 125° C. or below, about 120° C. or below, about 115° C. or below, about 110° C. or below, about 105° C. or below, about 100° C. or below, about 95° C. or below, or about 90° C. or below. In comparison, conventional spray drying systems have a much higher inlet temperature, typically about 150-250° C. or 180-230° C.

The atomizing temperature of the electrostatic spray drying system also is relatively low, such as about 80° C. or below (e.g., about 75° C. or below, about 70° C. or below, about 65° C. or below, about 60° C. or below, about 55° C. or below, about 50° C. or below, about 45° C. or below, about 40° C. or below, about 35° C. or below, or about 30° C. or below).

The electrostatic spray drying process applies a voltage to the spray droplets, which typically is about 0.1 kV or more (e.g., about 0.5 kV or more, about 1 kV or more, about 2 kV or more, about 4 kV or more, about 5 kV or more, about 7 kV or more, about 9 kV or more, about 12 kV or more, or about 15 kV or more). The upper limit of the applied voltage typically is 30 kV and in some instances, the upper limit is 20 kV or more preferably 15 kV. Any two of the foregoing endpoints can be used to define a close-ended range, or a single endpoint can be used to define an open-ended range. In the drying process, the applied voltage can be either continuous or modulated between two or more different voltages, known as Pulsed Width Modulation (PWM). Any two or more applied voltages ranging between 0.1-30 kV (e.g., 0.5 kV and 1 kV, 1 kV and 5 kV; 5 kV and 15 kV) can be used for PWM to provide a desired effect, such as a particular agglomerate size. It has been discovered that agglomerate size of an electrostatic spray dried milk powder increases as a function of electrostatic charge.

Alternatively, or in addition, to PWM, the charge (positive or negative) of the applied voltage can be altered, as necessary. Without wish to be bound by any theory, it is believed that alternating the electrostatic charge can change the surface composition of the particle and/or the agglomeration properties. For example, an applied negative charge will allow more polar compounds to move towards the surface of the particle and non-polar compounds will remain near the core of the particle. Accordingly, a negative electrostatic charge typically is applied in the electrostatic spray dry process. In some embodiments, alternating the charge of the applied voltage is used when preparing a powdered milk product comprising colostrum.

As used herein the term “about” typically refers to ±1% of a value, ±5% of a value, or ±10% of a value.

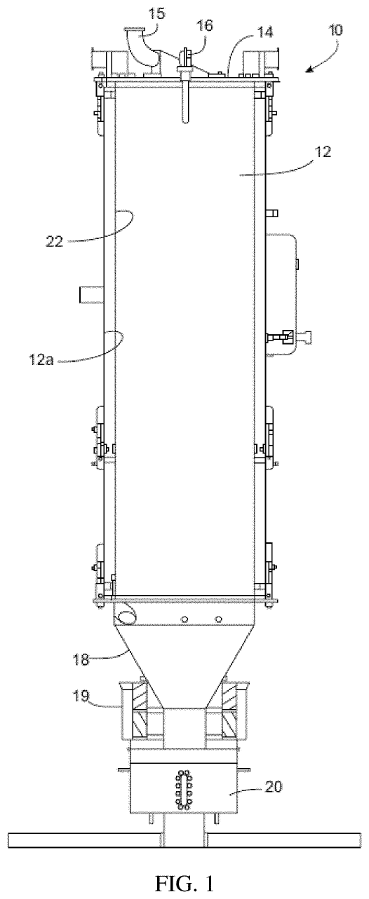

Referring now more clearly to the drawings, FIG. 1 is an illustrated spray drying system 10 for processing milk products into powder form according to the invention. A basic construction and operation of the illustrated spray drying system 10 is similar to that disclosed in U.S. Pat. No. 10,286,411, assigned to the same assignee as the present application, the disclosure of which is incorporated herein by reference.

The spray drying system 10 in this case includes a processing tower 11 comprising a drying chamber 12 in the form of an upstanding cylindrical structure, a top closure arrangement in the form of a cover or lid 14 for the drying chamber 12 having a heating air inlet 15 and a liquid spray nozzle assembly 16, and a bottom closure arrangement in the form of a powder collection cone 18 supported at the bottom of the drying chamber 12, a filter element housing 19 through which the powder collection cone 18 extends having a heating air exhaust outlet, and a bottom powder collection chamber 21.

The illustrated drying chamber 12 has a “replaceable internal non-metallic” insulating liner 22 disposed in concentric spaced relation to the inside wall surface 12a of the drying chamber 12 into which electrostatically charged liquid spray particles from the spray nozzle assembly 16 are discharged. The liner 100 has a diameter d less than the internal diameter dl of the drying chamber 12 so as to provide an insulating air spacing 101 with the inner wall surface 12a of the drying chamber 12. The liner 100 preferably is non-structural being made of a non-permeable flexible plastic material.

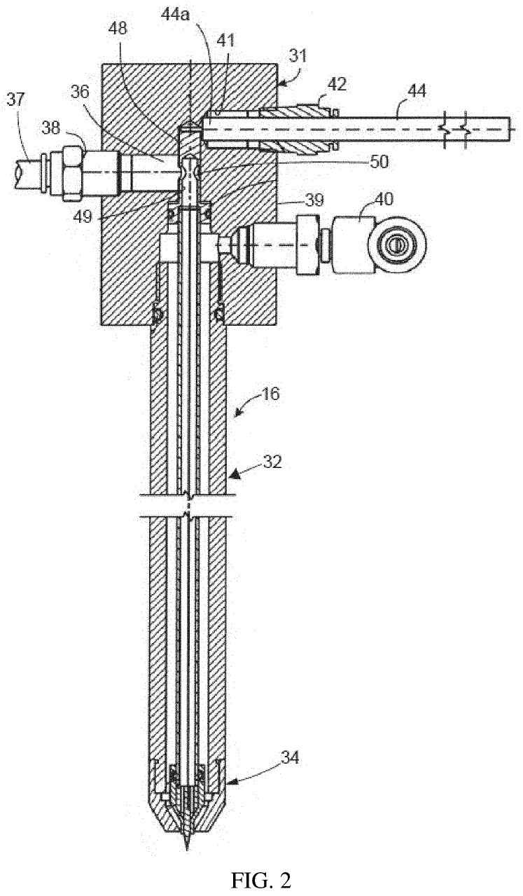

The spray nozzle assembly 16, as best depicted in FIG. 2, is a pressurized air assisted electrostatic spray nozzle assembly for directing a spray of electrostatically charged particles into the dryer chamber 12 for quick and efficient drying of milk products into powder form. The illustrated spray nozzle assembly 16, includes a nozzle supporting head 31, an elongated nozzle barrel or body 32 extending downstream from the head 31, and a discharge spray tip assembly 34 at a downstream end of the elongated nozzle body 32. The head 31 in this case is made of plastic or other non-conductive material and formed with a radial liquid inlet passage 36 that receives and communicates with a liquid inlet fitting 38 for coupling to a supply line 37 that communicates with a supply of a milk product to be spray dried.

The nozzle supporting head 31 in this case further is formed with a radial pressurized air atomizing inlet passage 39 downstream of said liquid inlet passage 36 that receives and communicates with an air inlet fitting 40 coupled to a suitable pressurized gas supply. The head 31 also has a radial passage 41 upstream of the liquid inlet passage 36 that receives a fitting 42 for securing a high voltage cable 44 connected to a high voltage source and having an end 44a extending into the passage 41 in abutting electrically contacting relation to an electrode 48 axially supported within the head 31 and extending downstream of the liquid inlet passage 36.

For enabling liquid passage through the head 31, the electrode 48 is formed with an internal axial passage 49 communicating with the liquid inlet passage 36 and extending downstream though the electrode 48. The electrode 48 is formed with a plurality of radial passages 50 communicating between the liquid inlet passage 36 and the internal axial passage 49.

The elongated body 32 is in the form of an outer cylindrical body member 55 made of plastic or other suitable nonconductive material, having an upstream end 55a threadably engaged within a threaded bore of the head 31. The liquid feed tube 58 is disposed in electrical contacting relation with the electrode 48 for efficiently electrically charging liquid throughout its passage from the head 31 and through elongated nozzle body member 32 to the discharge spray tip assembly 34, which in this case is similar to that disclosed in U.S. Pat. No. 10,286,411.

As will become apparent, the electrostatic spray drying system 10 is operable for drying milk products into fine particles with improved characteristics over the prior art.

The invention is further illustrated by the following features.

(1) An electrostatic spray dried powdered milk product with a surface composition comprising at least 8% less fat compared to a spray dried powder of the same milk product.

(2) The electrostatic spray dried powdered milk product of feature (1), wherein about 10% or more of the surface composition comprises a carbohydrate.

(3) The electrostatic spray dried powdered milk product of feature (1) or (2), wherein the powdered milk product is agglomerated.

(4) The electrostatic spray dried powdered milk product of feature (3), wherein the agglomerate size is 100 μm or more.

(5) The electrostatic spray dried powdered milk product of feature (4), wherein the agglomerate size is 300 μm or more.

(6) The electrostatic spray dried powdered milk product of any one of features (1)-(5), wherein the milk product comprises colostrum.

(7) The electrostatic spray dried powdered milk product of any one of features (1)-(6), wherein the milk product is from a mammal source selected from cattle, sheep, goat, horse, donkey, camel, moose, water buffalo, yak, reindeer, and any combination thereof.

(8) The electrostatic spray dried powdered milk product of feature (7), wherein the mammal source is cattle.

(9) The electrostatic spray dried powdered milk product of any one of features (1)-(8), wherein the milk product has a fat content of about 3-6%.

(10) The electrostatic spray dried powdered milk product of any one of features (1)-(9), wherein the milk product is fresh.

(11) The electrostatic spray dried powdered milk product of any one of features (1)-(10), wherein the milk product is reconstituted from a powder.

(12) The powdered milk product of any one of features (1)-(11), wherein the powdered milk product is electrostatically spray dried at an inlet temperature of below 150° C.

(13) The electrostatic spray dried powdered milk product of feature (12), wherein the atomizing temperature is about 80° C. or below.

(14) The electrostatic spray dried powdered milk product of feature (12) or (13), wherein the applied voltage is about 0.1 kV or more.

(15) The electrostatic spray dried powdered milk product of feature (14), wherein the applied voltage is continuous.

(16) The electrostatic spray dried powdered milk product of feature (14), wherein the applied voltage is modulated between two or more different voltages.

(17) The electrostatic spray dried powdered milk product of any one of features (12)-(14), wherein the applied voltage alternates charges.

(18) A method of providing a powdered milk product comprising electrostatic spray drying a milk product at an inlet temperature of below 150° C.

(19) The method of feature (18), wherein the atomizing temperature is about 80° C. or below.

(20) The method of feature (18) or (19), wherein the applied voltage is about 0.1 kV or more.

(21) The method of any one of features (18)-(20), wherein the applied voltage is continuous.

(22) The method of any one of features (18)-(20), wherein the applied voltage is modulated between two or more different voltages.

(23) The method of any one of features (18)-(20), wherein the applied voltage alternates charges.

(24) The method of any one of features (18)-(23), wherein the powdered milk product has a surface composition comprising at least 8% less fat compared to a spray dried powder of the same milk product.

(25) The method of any one of features (18)-(24), wherein the powdered milk product has a surface composition comprising about 10% or more of a carbohydrate.

(26) The method of any one of features (18)-(25), wherein the powdered milk product is agglomerated during the electrostatic spray process.

(27) The method of feature (26), wherein the agglomerate size is 100 μm or more.

(28) The method of feature (27), wherein the agglomerate size is 300 μm or more.

(29) The method of any one of features (18)-(28), wherein the milk product comprises colostrum.

(30) The method of any one of features (18)-(29), wherein the milk product is from a mammal source selected from cattle, sheep, goat, horse, donkey, camel, moose, water buffalo, yak, reindeer, and any combination thereof.

(31) The method of feature (30), wherein the mammal source is cattle.

(32) The method of any one of features (18)-(31), wherein the milk product has a fat content of about 3-6%.

(33) The method of any one of features (18)-(32), wherein the milk product is fresh.

(34) The method of any one of features (18)-(32), wherein the milk product is reconstituted from a powder.

(35) The method of feature (34), further comprising drying the reconstituted milk product prior to electrostatic spray drying the milk product.

The following examples further illustrate the invention but, of course, should not be construed as in any way limiting its scope.

### Example 1

This example demonstrates low temperature electrostatic spray drying of a milk product in an embodiment of the invention.

Full cream milk evaporated to 40% solids was electrostatically spray dried to form a powder at an inlet temperature of 90° C., an atomizing temperature of 35° C., and an electrostatic charge of 5 kV. The resulting milk powder had a similar bulk composition to milk powders produced by traditional spray drying at an inlet temperature of 180° C. and an outlet temperature of 90° C. (Table 1). Powders made by both spray drying methods had a moisture content between 1-1.5% and water activity between 0.07-0.099.

TABLE 1

| | Bulk composition | | | | | |
|---|---|---|---|---|---|---|
| | Fat | Protein | Carbohydrate | Ash | Moisture | Water |
| | (%) | (%) | (%) | (%) | (%) | Activity |
| Spray dried | 21.8 | 24.8 | 5.20 | 5.20 | 1.03 ± 0.06 | 0.077 ± 0.013 |
| Electrostatic | 21.4 | 24.9 | 5.20 | 5.20 | 1.54 ± 0.05 | 0.099 ± 0.017 |
| spray dried | | | | | | |

Single strength milk (12-13% solids with varying fat content) and concentrated milks with higher solids content can also be dried electrostatically. The electrostatic technology at inlet temperatures below 150° C., atomizing temperatures below 80° C., and electrostatic charge above 0.1 kV produces milk powders with a moisture content ≤5% and water activity ≤0.3, typical of high heat spray dried milk powders. Typical high heat spray drying conditions used in milk powder manufacture are compared with electrostatic spray drying in Table 2. In traditional high heat spray drying, it becomes increasingly difficult to dry milk powder as the inlet temperature drops, and powders cannot be produced with moisture content below 5% and water activity below 0.3 at inlet and outlet temperatures typical of electrostatic spray drying.

TABLE 2

| | Inlet | Atomizing | Outlet | Electrostatic |
|---|---|---|---|---|
| | temperature | temperature | temperature | charge |
| | (° C.) | (° C.) | (° C.) | (kV) |
| Spray drying | 150-250* | NA | 70-90* | NA |
| | 180-230** | | | |
| Electrostatic | ≤150 | ≤70 | ≤70 | ≥0.1 |
| spray drying | | | | |

NA: not applicable
*S. Padma Ishwarya and C. Anandharamakrishnan, “Spray Drying” in Handbook of Drying for Dairy Products, 1st Ed., John Wiley & Sons, 2017, pages 57-94
**Bloore & O'Callaghan, “Process Control in Evaporation and Drying” in Dairy Powders and Concentrated Products, Wiley-Blackwell, 2009, pages 332-350; and Kelly et al., “Manufacture and Properties of Milk Powders” in Advanced Dairy Chemistry Volume 1: Proteins, 3rd Ed., Kluwer Academic/Plenum Publishers, 2003, pages 1027-1061

### Example 2

This example demonstrates that electrostatic spray dried milk powders retain “milky-white” appearance.

The color parameters of full cream milk powders were measured using the CIELAB (International Commission on Illumination L*a*b*) system, in which L* defines lightness, a* denotes the red/green value, and b* is the yellow/blue value. A color movement towards the +b direction depicts a shift toward yellow. Full cream milk spray dried by traditional high heat methods tends to lose its characteristic “milky-white” appearance in the powder form and develops a slightly yellow tinge.

Milk powders prepared by high heat spray drying and electrostatic spray drying, as set forth in Example 1 above, were prepared and analyzed. As shown in Table 3 both powder types display similar lightness (L* values). However, the yellowness in the electrostatically spray dried full cream milk powders is lower, as evidenced by lower b* values, than traditional spray dried powders formed using high heat. A less yellow, “whiter” appearance is desirable from a consumer standpoint, since a less yellow color has a more natural appearance. Without being bound to a particular theory, the reduced yellowness is likely due to low temperatures used in electrostatic spray drying, a lower surface fat (Table 5 below), and/or a smaller primary particle size (Table 6 below).

TABLE 3

| | CIELAB Color | |
|---|---|---|
| | L* | b* |
| Spray dried | 95.34 ± 0.08 | 12.88 ± 0.16 |
| Electrostatic spray dried | 96.81 ± 0.52 | 10.97 ± 0.60 |

### Example 3

This example demonstrates that electrostatic spray dried powders have reduced non-enzymatic browning after heating in an embodiment of the invention.

Milk powders prepared by high heat spray drying and electrostatic spray drying, as set forth in Example 1 above, were prepared and analyzed. Table 4 shows the color parameters of full cream milk powders heated at 102° C. for 2 hrs. Although non-enzymatic browning was evident in both powders after heating, as evidenced by higher b* values than reported in Table 3, the electrostatic spray dried powders were less affected by browning (lower b* values).

TABLE 4

| | Color of heated milk powder | |
|---|---|---|
| | L* | b* |
| Spray dried | 88.51 ± 0.23 | 27.17 ± 0.21 |
| Electrostatic spray dried | 87.90 ± 0.73 | 24.56 ± 0.41 |

### Example 4

This example demonstrates electrostatic spray drying of a whole milk product with lower surface fat composition in an embodiment of the invention.

Milk powders prepared by high heat spray drying and electrostatic spray drying, as set forth in Example 1 above, were prepared and analyzed. The bulk composition of both types of whole milk powders is compared with surface composition in Table 5. Both the spray dried and electrostatic spray dried powders have similar fat, protein, and carbohydrate (CHO) bulk composition, however, their surface chemistry differs. Although fat contributed to approximately 21.5% of the bulk composition, the fat is over-represented on the surface of the powder, followed by protein and CHO (e.g., lactose). The spray dried powders had almost 78% surface fat, whereas the electrostatically spray dried powders had approximately 69% surface fat. Thus, the electrostatic effect lowers surface fat by almost 10% and fat on the surface is replaced predominantly by carbohydrate (e.g., lactose) and some protein.

TABLE 5

| | Bulk composition (%) | | | Surface composition (%) | | |
|---|---|---|---|---|---|---|
| | Fat | Protein | CHO | Fat | Protein | CHO |
| Spray dried | 21.8 | 24.8 | 5.20 | 77.85 ± 3.43 | 16.56 ± 2.83 | 5.59 ± 0.59 |
| Electrostatic | 21.4 | 24.9 | 5.20 | 68.90 ± 0.21 | 20.72 ± 0.48 | 10.38 ± 0.70 |
| spray dried | | | | | | |

### Example 5

This example demonstrates agglomeration of primary particles during the electrostatic spray drying process of a milk product in an embodiment of the invention.

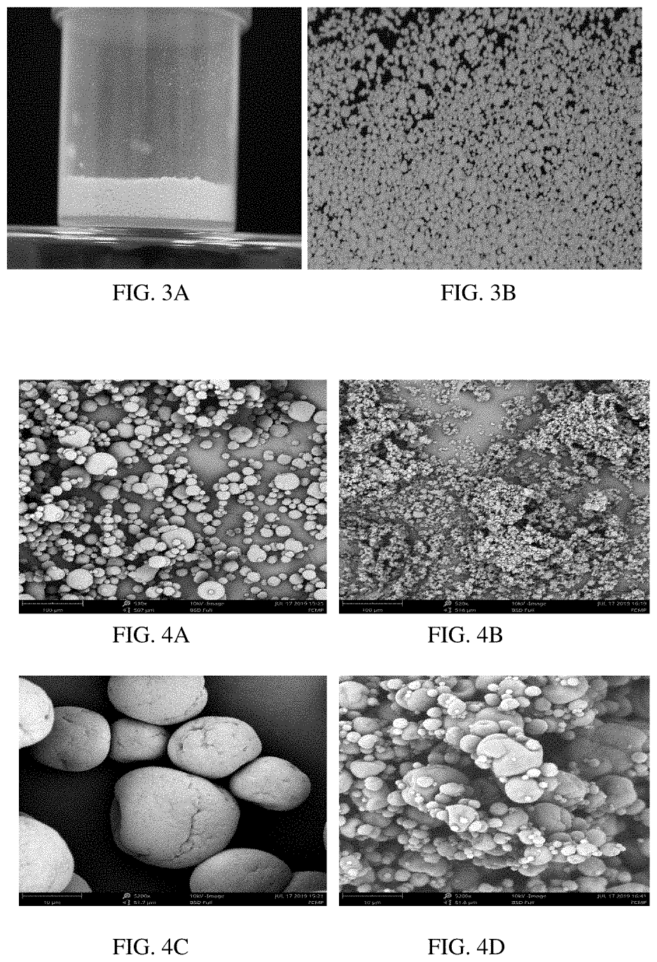

Electrostatic spray drying produces highly agglomerated, granular-like powders as shown in FIGS. 3A (macro view) and 3B (micro view). Agglomeration takes place during the spray drying process and is induced by the electrostatic charge. Unlike traditional high heat spray drying, agglomeration does not involve re-use of fines or agglomerating agents. Post-drying agglomeration methods (e.g., fluidized bed agglomeration) generally are not required, as is often applied post drying. Agglomeration typically is indicative of improved wettability, which is a key measure of shelf life and ability to reconstitute. Wettability (i.e., capacity of powder particles to absorb water on their surface) can be measured by any suitable method, such as IDF (1979) (“Determination of the dispersibility and wettability of instant dried milk.” IDF Standard No. 87. International Dairy Federation, Brussels) and GEA Niro Method No. A 6 a (revised 2005).

Milk powders prepared by high heat spray drying and electrostatic spray drying, as set forth in Example 1 above, were prepared and analyzed. Single strength milk (˜13% solids) was used to prepare electrostatic spray dried powder for this data set. Table 6 shows that the average agglomerate size of electrostatic spray dried powders was approximately 384 μm. The large standard deviation (±226 μm) implies a broad range of agglomerate sizes. Spray dried powders do not agglomerate during the drying process, and the primary particle size was approximately 33 μm. This was larger than the primary particle size of electrostatically spray dried powders (˜12 μm), i.e., the agglomerating particles.

TABLE 6

| | Spray dried | Electrostatically spray dried |
|---|---|---|
| Aggregate size (μm) | 32.8 ± 9.0 | 384.1 ± 226.7 |
| Primary particle size (μm) | 32.8 ± 9.0 | 12.1 ± 1.2 |

Scanning electron micro-images confirm these data (FIGS. 4A-4D). FIG. 4A and FIG. 4C show the large unagglomerated primary particles of the spray dried powder at 500 and 5000× magnification, respectively. FIG. 4B shows the highly agglomerated electrostatic spray dried powders at 500× magnification, whereas FIG. 4D shows the small agglomerated primary particles at 5000× magnification.

Electrostatic spray dried powders at an inlet temperature of 90° C. and an atomizing temperature of 35° C. were prepared using Pulsed Width Modulation (PWM) at two different voltages, a high charge and a low charge. As shown in Table 7, agglomerate size can be controlled by manipulating the electrostatic charge during the spray drying process.

TABLE 7

| High Electrostatic | Low Electrostatic | Agglomerate Size |
|---|---|---|
| Charge (kV) | Charge (kV) | (μm) |
| 1 | 0.5 | 521 |
| 5 | 1 | 420 |
| 15 | 5 | 385 |

### Example 6

This example demonstrates the low temperature electrostatic spray drying of colostrum in an embodiment of the invention.

Liquid colostrum containing approximately 23% solids (w/w) was dried with an electrostatic spray drier (ESD) at operating conditions specified in Table 8.

TABLE 8

| Parameter | ESD (90° C.) | ESD (150° C.) |
|---|---|---|
| Inlet temp (° C.) | 90 | 150 |
| Atomizing temp (° C.) | 30 | 80 |
| Atomizing gas pressure (kPa) | 210 | 210 |
| Voltage (High/Low) (kV) | 5/1 | 5/1 |
| Charge | negative | negative |

Colostrum powders were made by electrostatic spray drying at inlet temperatures of 90° C. and 150° C., however, the inlet drying temperature can be as low as 80° C. Exhaust temperatures are generally maintained below 60° C., and in this example, exhaust temperatures were maintained at 30° C. (90° C. inlet) and 60° C. (150° C. inlet). Negative pulsed width modulation (PWM) alternating between 5 kV and 1 kV was used in the drying process, however, this can be as high as 15 kV with or without PWM, and the charge can be reversed (positive). Atomizing gas pressure was 200 kPa, but this can range from 30-552 kPa. Spray drying temperatures reported in the literature for colostrum are generally higher (180° C. inlet) compared to ESD. See, e.g., Borad et al. (LWT—Food Science and Technology, 118, 108719, 6 pages (2020)).

The typical moisture content and water activity for electrostatic spray dried colostrum powders is below 4% moisture and water activity of 0.2. In this example, these parameters are shown in Table 9. At a 90° C. inlet drying temperature, the moisture content of ESD colostrum powders was 0.79%, and the water activity was 0.092. Electrostatic spray drying at 150° C. produced colostrum powders with a similar moisture content and water activity (0.83% and 0.099, respectively).

TABLE 9

| | Moisture (%) | Water Activity |
|---|---|---|
| ESD (90° C.) | 0.79 ± 0.21 | 0.092 ± 0.012 |
| ESD (150° C.) | 0.83 ± 0.20 | 0.099 ± 0.035 |

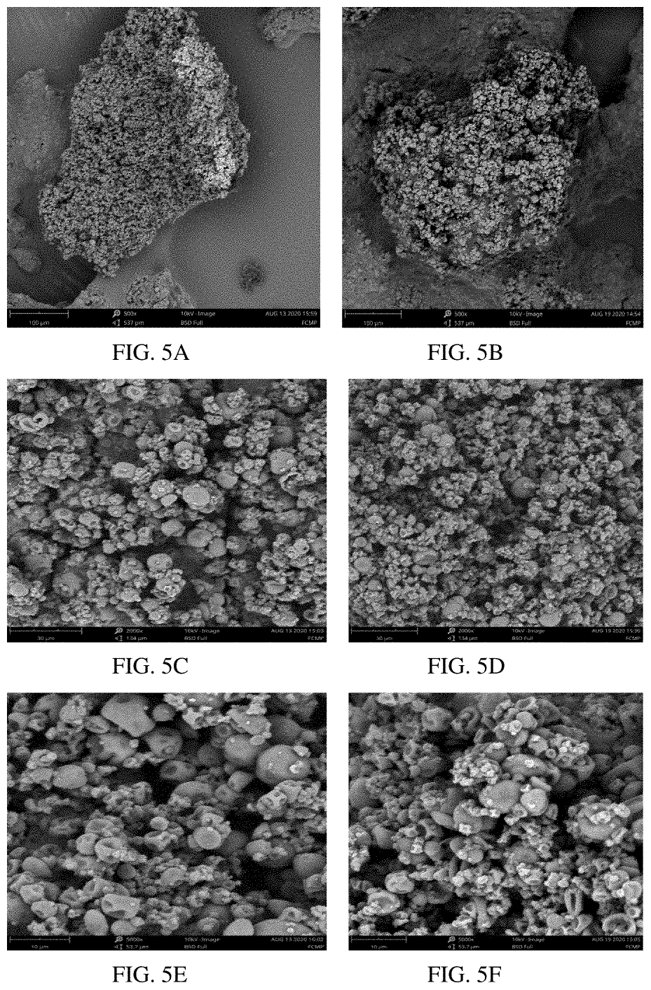

Scanning electron microscope (SEM) images for ESD colostrum powders at 500×, 2000× and 5000× magnification were taken. See FIG. 5. At both temperatures and at the lower reported magnification (500×), ESD powders were agglomerated (FIGS. 5A and 5B). At both temperatures and higher magnification (2000× and 5000×), the primary powder particles were clearly visible (FIGS. 5C-5F). There is a clear distribution in the size of primary particles and the majority of these were predominantly spherical in appearance.

The lactoferrin and IgG contents in colostrum powders were determined by the ELISA Quantitation method (ELISA Kit, Catalogue No, E10-126, Bethyl Laboratories, Montgomery, Tex., USA).

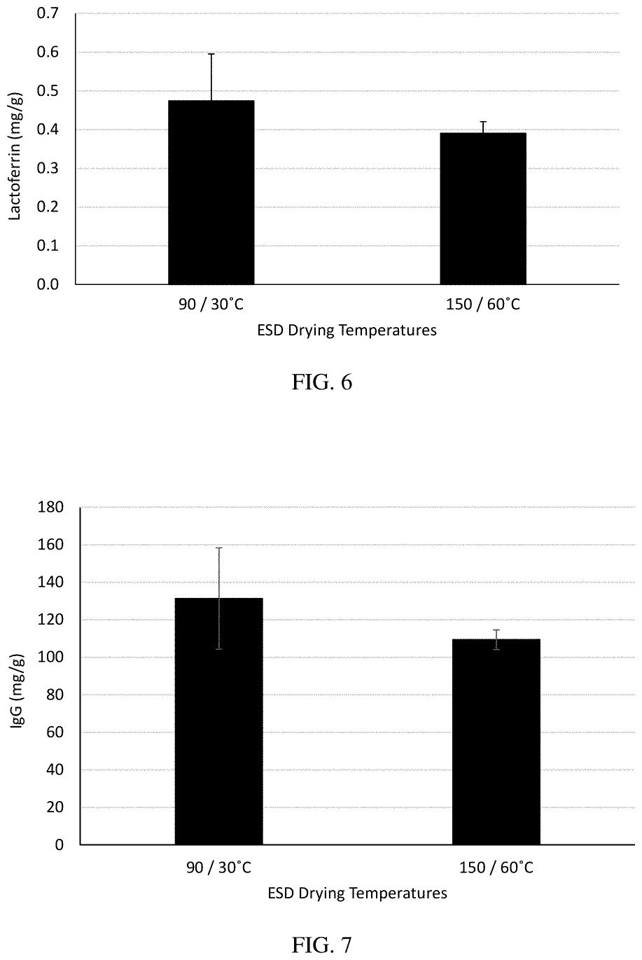

FIG. 6 shows the lactoferrin content in colostrum powders. Data indicated that colostrum powders dried at 90° C. had 90% bioactive yield retention (based on 0.53 mg/g active lactoferrin in the liquid colostrum before drying). At the higher inlet drying temperature of 150° C., there was some loss in lactoferrin bioactivity and yield retention was 74%. FIG. 7 shows the IgG content in colostrum powders. Data indicated that colostrum powders dried at 90° C. had 98% bioactive yield retention (based on 134 mg/g active IgG in the liquid colostrum before drying). At the higher inlet drying temperature of 150° C., there was some loss in IgG bioactivity and yield retention was 82%.

### Example 7

This example demonstrates the low temperature electrostatic spray drying of lactoferrin (Lf) in an embodiment of the invention.

Liquid lactoferrin containing approximately 12% solids (w/w) was dried with an electrostatic spray drier at operating conditions specified in Table 10. For comparison, the lactoferrin was also freeze dried as specified in Table 11.

TABLE 10

| | ESD | ESD | Spray |
|---|---|---|---|
| Parameter | (−ve charge) | (+ve charge) | Dried |
| Inlet temp (° C.) | 90 | 90 | 150 |
| Atomizing temp (° C.) | 30 | 30 | 80 |
| Atomizing gas pressure (kPa) | 200 | 200 | 200 |
| PWM voltage (High/Low) (kV) | 5/1 | 5/1 | 0 |
| Charge | −ve | +ve | NA |

NA: not applicable

TABLE 11
Freeze Drying Parameter

| | |
|---|---|
| Overnight freezing (° C.) | −20 |
| Coil temperature (° C.) | −80 |
| Shelf temperature (° C.) | −40 |
| Drying time (hrs) | 72 |
| Drying Vacuum (Pa) | 12 |

Lactoferrin powders were made by electrostatic spray drying at 90° C. inlet, however, the inlet drying temperature can be as low as 80° C. and as high as 150° C. Exhaust temperatures were maintained below 60° C. and in this example, these parameters were set to 30° C. Positive and negative pulsed width modulation (PWM) alternating between 5 kV and 1 kV was used in the drying process, however, this can be as high as 15 kV with or without PWM. Atomizing gas pressure was 200 kPa but this can range from 30-552 kPa.

The typical moisture content and water activity for electrostatic spray dried lactoferrin powders is below 4% moisture and water activity of 0.2. In this example, the moisture content and water activity for electrostatic spray dried lactoferrin powders is shown in Table 12. At a 90° C. inlet drying temperature, the moisture content of Lf powders was 2.52% with negative PWM and 1.50% with positive PWM. Water activity was 0.222 and 0.144 for negative and positive PWM, respectively. Spray drying at 150° C. without electrostatic charge produced powders with similar moisture content and water activity (2.30% and 0.248, respectively). The moisture content of freeze dried Lf powders was lower at 1.18% and 0.108 water activity.

TABLE 12

| | Moisture (%) | Water Activity |
|---|---|---|
| Electrostatic spray dried (−ve) | 2.52 ± 0.81 | 0.222 ± 0.003 |
| Electrostatic spray dried (+ve) | 1.50 ± 0.57 | 0.144 ± 0.005 |
| Spray dried | 2.30 ± 0.89 | 0.248 ± 0.001 |
| Freeze dried | 1.18 ± 0.21 | 0.108 ± 0.005 |

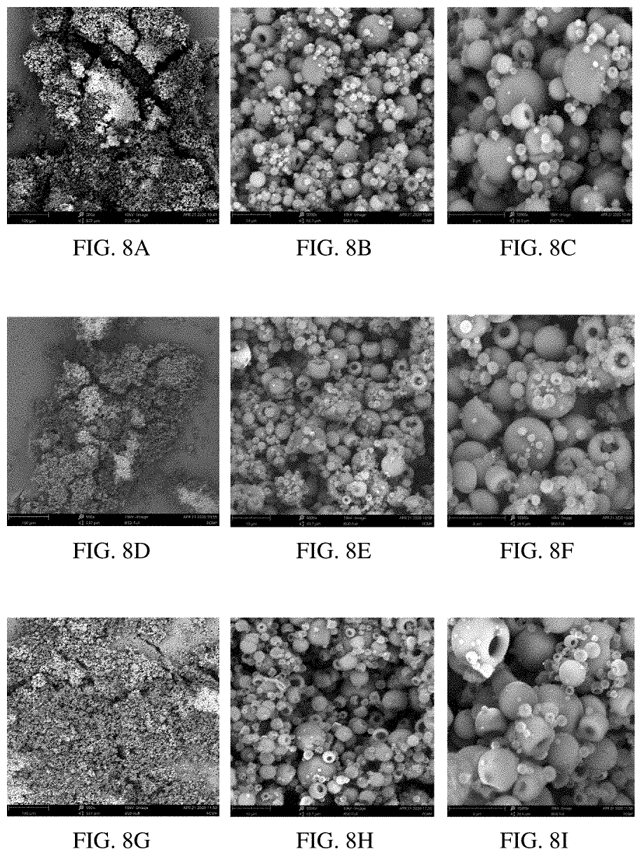

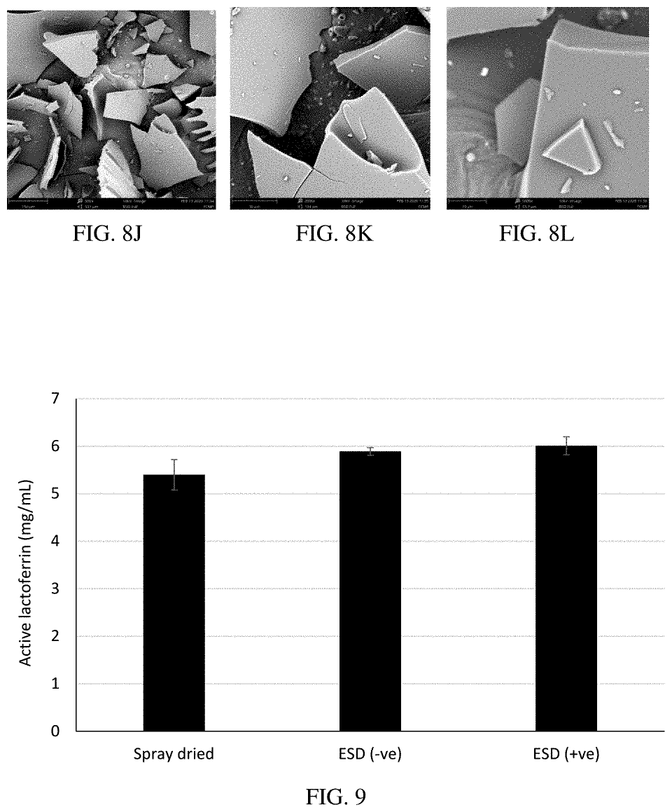

FIG. 8 is a series of SEM images for spray dried and ESD Lf powders at 500×, 5000×, and 10,000× magnification. At the lower reported magnification (500×), ESD powders show agglomeration (FIGS. 8A and 8D), however, the spray dried powders are widely dispersed and show little agglomeration in the absence of electrostatic charge (FIG. 8G). At higher magnification (5000× and 10,000×), the primary powder particles are clearly visible (FIGS. 8B, 8C, 8E, 8F, 8H, and 8I). Primary particles are predominantly spherical in appearance and surface depressions are evident. These depressions are typically found in spray dried low-fat dairy powders dried at low temperatures (see, e.g., Nijdam et al., Journal of Food Engineering, 77, 919-925 (2005)).

The morphology of freeze dried lactoferrin shows a typical crystalline, sharp edged appearance and differs to the spherical spray dried and ESD powders (FIGS. 8J, 8K, and 8L).

FIG. 9 shows the bioactive lactoferrin content in Lf powders using a bovine lactoferrin ELISA Quantitation kit (Catalogue No, E10-126, Bethyl Laboratories, Montgomery, Tex., USA). Based on 6 mg/mL for the ELISA assay, the Lf powders spray dried at 150° C. inlet temperature and without electrostatic charge retained 90% of their bioactivity. Regardless of the PWM charge (negative or positive), ESD powders were processed at a milder inlet temperature of 90° C. and showed 98% and 100% retention of the lactoferrin biological activity, respectively.

### Example 8

This example demonstrates the low temperature electrostatic spray drying of whey protein powder in an embodiment of the invention.

Whey protein concentrate (WPC) solutions containing 20% solids (w/w) were dried with an electrostatic spray drier at operating conditions specified in Table 13.

TABLE 13

| Parameter | Drying Conditions |
|---|---|
| Inlet temp (° C.) | 90-150 |
| Atomizing temp (° C.) | 30-80 |
| Atomizing gas pressure (kPa) | 200 |
| PWM voltage (High/Low) (kV) | 5/1 |
| Charge | Negative |

The dried product was a whey protein powder containing up to 80% protein (WPC80). WPC powders were made by electrostatic spray drying at inlet temperatures ranging from 90° C. and 150° C., however, the inlet drying temperature can be as low as 80° C. Atomizing and exhaust temperatures ranged from 30-80° C. A positive pulsed width modulation (PWM) charge alternating between 5 kV and 1 kV was used in the drying process, however, this can be as high as 15 kV with or without PWM, and the charge can be reversed (positive). The atomizing gas pressure was 200 kPa but can range from 30-552 kPa.

The typical moisture content and water activity for electrostatic spray dried whey powders is below 4% moisture and water activity of 0.2. In this example, the moisture content and water activity for electrostatic spray dried WPC powders is shown in Table 14. At a 90° C. inlet drying temperature, the moisture content of WPC powders was 2.12% with a water activity of 0.074. As the drying temperature increased to 150° C., the moisture content of WPC80 powders dropped to 0.97% and 0.019 water activity. These moisture contents of ESD WPC powders is lower than whey powders produced by traditional high heat spray drying operating at higher temperatures. Traditional high heat spray dryers typically operate at inlet temperatures ranging from 160->200° C. and the resulting powders have a moisture content ranging from 3-7% (see, e.g., Oliveira et al., J Food Sci Technol, 55(9), 3693-3702 (2018); Sawhney et al., Journal of Food Processing and Preservation, 38, 1787-1798 (2014); and Svanborg et al., J. Dairy Sci., 98, 5829-5840 (2015)).

TABLE 14

| | Moisture (%) | Water Activity |
|---|---|---|
| Electrostatic spray dried | 2.12 ± 0.20 | 0.074 ± 0.040 |
| (90° C. inlet; 30° C. atomizing) | | |
| Electrostatic spray dried | 0.97 ± 0.32 | 0.019 ± 0.002 |
| (150° C. inlet; 80° C. atomizing) | | |

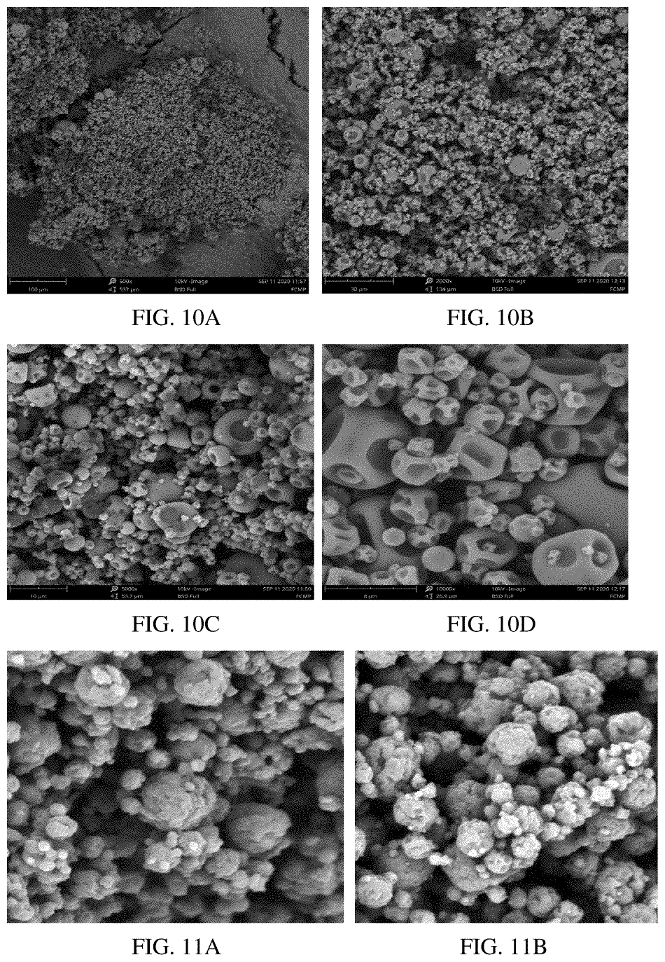

FIG. 10 is a series of SEM images for WPC powders at 500×, 2000×, 5000× and 10,000× magnification. The lower reported magnifications (500× and 2000×) show that electrostatic spray dried WPC powders are highly agglomerated (FIGS. 10A and 10B). At higher magnifications (5,000× and 10,000×), the primary powder particles are clearly visible (FIGS. 10C and 10D). Although primary particles are predominantly spherical in appearance, non-hollow depressions exist on the surface of each particle. These depressions are typical of low-fat dairy powders dried at low temperature (see, e.g., Nijdam et al., Journal of Food Engineering, 77, 919-925 (2005)), and the morphology differs to powders dried at high temperatures typical of traditional spray drying (see, e.g., Barone et al., Journal of Food Engineering, 255, 41-49 (2019); and Nishanthi et al., Journal of Food Engineering, 219, 111-120 (2018)).

### Example 9

This example demonstrates the low temperature electrostatic spray drying of yogurt in an embodiment of the invention.

Yogurts containing 13% and 20% solids (w/w) were fermented to pH 4.5 and 5.0 before electrostatic spray drying at the operating conditions specified in Table 15.

TABLE 15

| Parameter | Drying Conditions |
|---|---|
| Inlet temp (° C.) | 95 |
| Atomizing temp (° C.) | 40 |
| Atomizing gas pressure (kPa) | 340 |
| PWM voltage (High/Low) (kV) | 5/1 |
| Charge | Negative |

Yogurt powders were made by electrostatic spray drying at an inlet temperature of 95° C., however, the inlet drying temperature can be as low as 80° C. or as high as 150° C. Exhaust temperatures are generally maintained below 60° C., and in this example, the exhaust temperature was 40° C. Negative pulsed width modulation (PWM) alternating between 5 kV and 1 kV was used in the drying process, however, this can be as high as 15 kV with or without PWM and the charge can be reversed (positive). The atomizing gas pressure was 340 kPa, but this can range from 30-552 kPa. Spray drying temperatures for yogurt reported in the literature are generally greater than 170° C. inlet and exhaust temperatures above 60° C. (see, e.g., Kearney et al., International Dairy Journal, 19, 684-689 (2009); Koc et al., Drying Technology, 28(4), 495-507 (2010); Rascón-Díaz et al., Food Bioprocess Technol, 5, 560-567 (2012); and Seth et al., International Journal of Food Properties, 20(7), 1603-1611 (2016)).

The typical moisture content and water activity for electrostatic spray dried yogurt powders is lower than 4% moisture but can be as high as 5%, and water activity is less than 0.2. In this example, these parameters are shown in Table 16. At a 95° C. inlet drying temperature, the moisture content of yogurt powders was 3.28-4.10%, and the water activity was 0.116-0.127.

TABLE 16

| | Moisture (%) | Water Activity |
|---|---|---|
| ESD pH 4.5 (13% solids) | 3.46 ± 0.18 | 0.117 ± 0.002 |
| ESD pH 5.0 (13% solids) | 4.10 ± 0.33 | 0.119 ± 0.002 |
| ESD pH 4.5 (20% solids) | 3.30 ± 0.72 | 0.127 ± 0.045 |
| ESD pH 5.0 (20% solids) | 3.28 ± 0.73 | 0.116 ± 0.027 |

FIG. 11 is a series of SEM images for ESD yogurt powders at 10,000× magnification at pH 5.0 (FIG. 11A) and pH 4.5 (FIG. 11B). There is narrow size distribution between the primary particles and the majority of these are spherical in appearance. The surface of ESD yogurt powders is rough due to acidification and protein destabilization during the fermentation process.

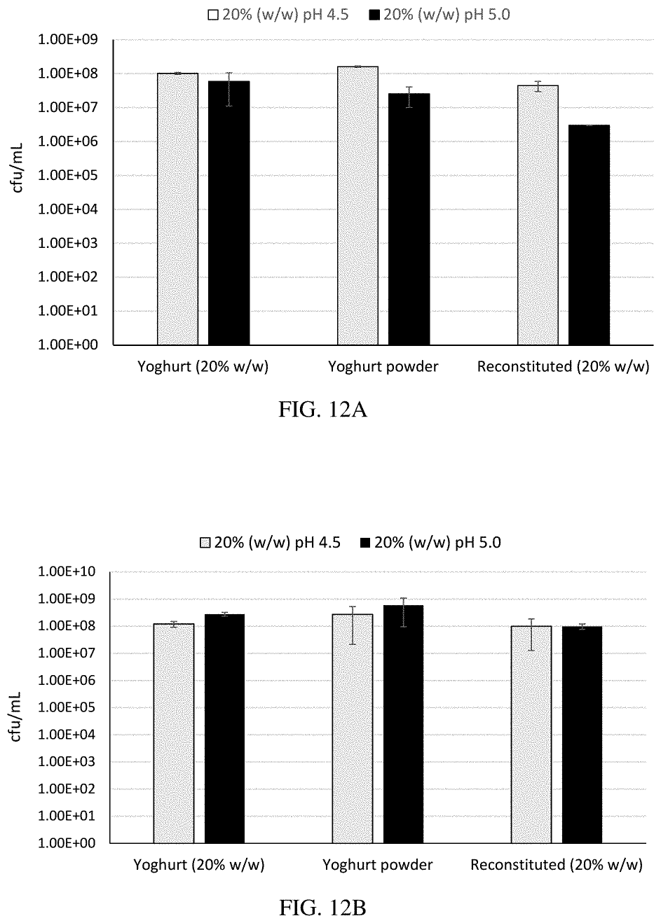

FIGS. 12A and 12B show the cell counts (cfu/mL) for L. delbrueckii subsp. Bulgaricus (FIG. 12A) and Streptococcus thermophilus (FIG. 12B) in 20% (w/w) yogurt fermented to pH 4.5 or pH 5.0. Cell counts also are provided for the corresponding ESD yogurt powder before and after reconstitution to 20% solids (w/w). Yogurts fermented to pH 4.5 and 5.0 had similar cell counts for both L. delbrueckii subsp. bulgaricus and Streptococcus thermophilus (˜10×⁸ cfu/mL). After electrostatic spray drying, yogurt powders had little to no loss of cell viability. This observation was also true for yogurt powders reconstituted to 20% (w/w) solids with the exception of L. delbrueckii subsp. bulgaricus in yogurt fermented to pH 5.0, in which a loss was recorded (˜10×⁶ cfu/mL).

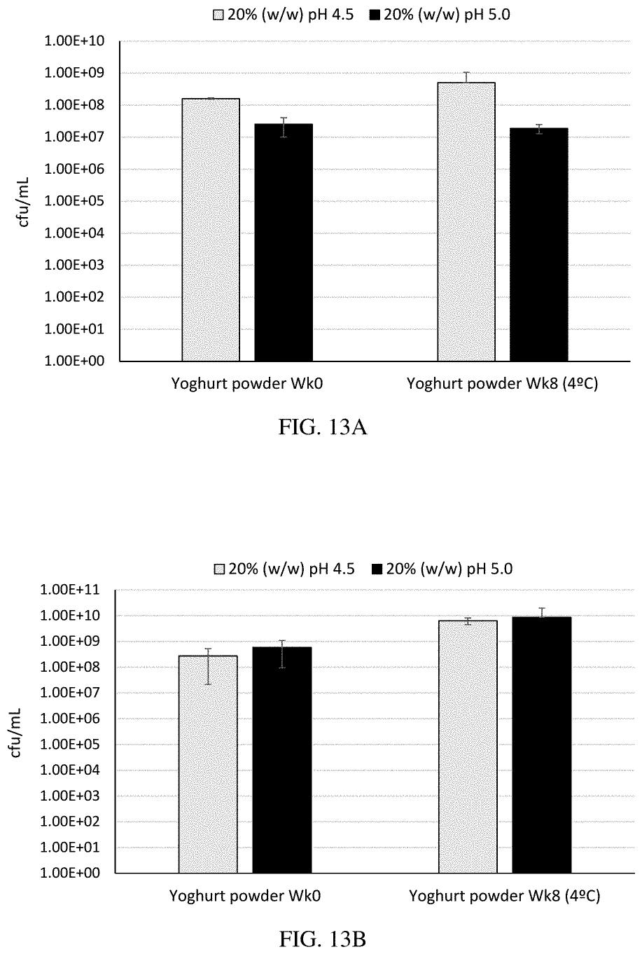

FIGS. 13A and 13B show the cell counts (cfu/mL) for L. delbrueckii subsp. bulgaricus (FIG. 13A) and Streptococcus thermophilus (FIG. 13B) in yogurt powders (yogurt was dried from 20% (w/w) skim milk fermented to pH 4.5 or pH 5.0) immediately after manufacture and after 8 weeks of storage at 4° C. Survival of living microorganisms in ESD yogurt powders remained high and there was little to no loss in cell viability over eight weeks of storage at 4° C.

### Example 10

This example demonstrates the low temperature electrostatic spray drying of infant milk formula (IMF) in an embodiment of the invention.

A 40% solids (w/w) IMF wet mix was prepared with lactose, skim milk powder, whey protein concentrate, and vegetable oil and contained 15% protein, 26% fat, and 59% lactose. Similar infant formulations have been reported in the literature. See, e.g., Masum et al., J. Food Eng., 2019, 254, 34-41; and Masum et al., Int. Dairy J., 2020, 100, 104565. Liquid IMF was dried with an ESD at the operating conditions set forth in Table 17. IMF was also spray dried by conventional high heat spray drying for comparison.

TABLE 17

| | ESD | ESD | Spray Dried |
|---|---|---|---|
| Parameter | (90/35) | (150/80) | (180/90) |
| Inlet temp (° C.) | 90 | 150 | 180 |
| Atomizing temp (° C.) | 35 | 80 | 90 |
| Atomizing gas pressure (kPa) | 240 | 340 | 300 |
| PWM voltage (High/Low) (kV) | 10/1 | NA | NA |
| Continuous voltage (kV) | NA | 0.9 | NA |
| Charge | −ve and +ve | −ve and +ve | NA |

NA: not applicable

IMF powders were made by electrostatic spray drying at inlet temperatures of 90° C. and 150° C., however, the inlet drying temperature can be as low as 80° C. Atomizing and exhaust temperatures are generally maintained below 60° C., and in this example, the atomizing and exhaust temperatures were set to 35° C. and 80° C. for powders dried at inlet temperatures of 90° C. and 150° C., respectively. The atomizing gas pressure can range from 30-552 kPa. The electrostatic charge can be as low as 0.1 and as high as 15 kV and with or without PWM. In this example, negative and positive pulsed width modulation (PWM) alternating between 10 kV and 1 kV was used when drying at 90/35° C., and a 0.9 kV continuous voltage was used when drying at 150/80° C.

For comparison, IMF was also spray dried at 180/90° C. by conventional high heat spray drying at drying conditions similar to those reported in the literature (see, e.g., Masum et al., J. Food Eng., 2019, 254, 34-41; Masum et al., Int. Dairy J., 2020, 105, 104696; McCarthy et al., Int. Dairy J., 2012, 25(2), 80-86; Montagne et al., “Infant Formulae—Powders and Liquids. In Dairy Powders and Concentrated Products,” 1st ed.; Tamime, A. Y., Ed.; Wiley-Blackwell: West Sussex, U K, 2009; pp 294-331; and Murphy et al., Int. Dairy J., 2015, 40, 39-46). See Table 17.

The typical moisture content and water activity for electrostatic spray dried IMF powders is below 4% moisture and water activity of 0.2. In this example, the powder properties are shown in Table 18. At 90° C. inlet drying temperature, the moisture content of colostrum powders was 2.29% and below, and the water activity was 0.114 and below. Electrostatic spray drying at 150° C. produced powders with even an even lower moisture content and water activity (e.g., 0.99% moisture and below and water activity of 0.028 and below). In comparison, traditional high heat spray dried powder had a moisture content and water activity of 1.89% and 0.210, respectively.

TABLE 18

| | Moisture (%) | Water Activity |
|---|---|---|
| ESD (90/35) −ve | 2.29 ± 0.02 | 0.114 ± 0.021 |
| ESD (150/80) −ve | 0.66 ± 0.13 | 0.028 ± 0.004 |
| ESD (90/35) +ve | 1.78 ± 0.04 | 0.087 ± 0.017 |
| ESD (150/80) +ve | 0.99 ± 0.02 | 0.026 ± 0.005 |
| Spray dried (180/90) | 1.89 ± 0.01 | 0.210 ± 0.008 |

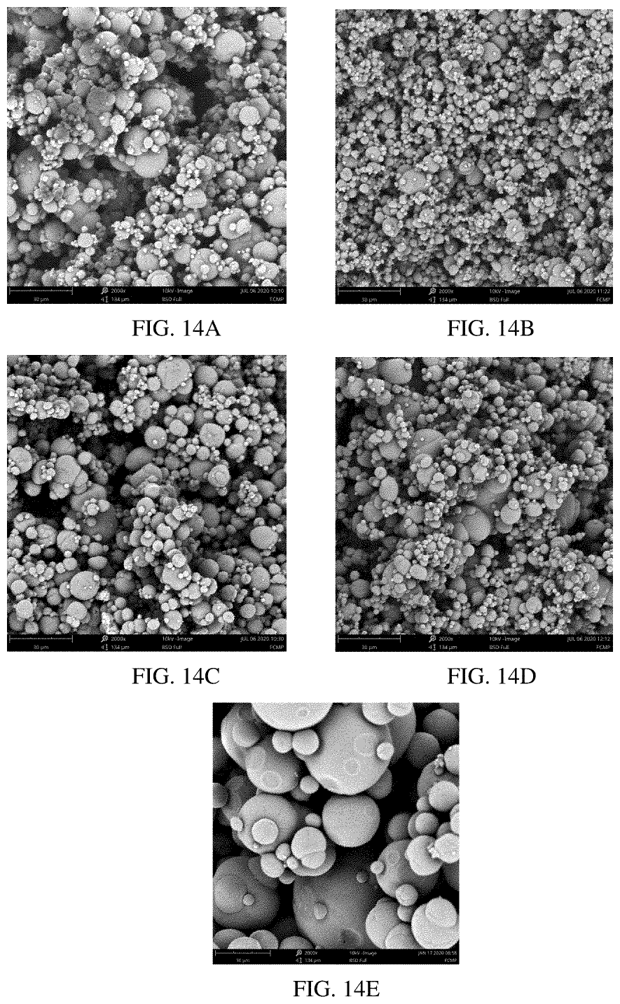

FIG. 14 is a series of SEM images at 2000× magnification for ESD powders dried at 90/35° C. (negative charge in FIG. 14A and positive charge in FIG. 14B), ESD powders dried at 150/80° C. (negative charge in FIG. 14C and positive charge in FIG. 14D), and spray dried IMF powder (FIG. 14E). As seen in the images, the ESD powders were agglomerated, and the primary particles were predominantly spherical in appearance. Spray dried primary particles also were spherical but were larger than the ESD powders.

Table 19 shows the characteristics and solubility of the powders immediately after ESD manufacture and traditional high heat spray drying. All the powders were free flowing immediately after manufacture (day 0), and the solubility was high (˜97-98%). All the powders stored at 54% relative humidity caked after both 1 week at 45° C. and after 4 weeks at 22° C. Although the powders caked, the solubility of the ESD powders remained high at ˜93-96%. IMF powders that were spray dried, however, had large losses in solubility dropping to ˜86% after storage at 22° C. and ˜78% after storage at 45° C.

TABLE 19

| | | Storage | Storage |
|---|---|---|---|
| | | (22° C.) | (45° C.) |
| Powder | Day 0 | Week 4 | Week 1 |
| Powder | Free flowing | Caked | Caked |
| characteristics | | | |
| | Solubility (%) | | |
| ESD (90/35) −ve | 96.82 ± 1.74 | 95.83 ± 0.35 | 94.46 ± 2.12 |
| ESD (150/80) −ve | 96.66 ± 1.10 | 95.97 ± 1.37 | 93.93 ± 0.47 |
| ESD (90/35) +ve | 96.27 ± 1.05 | 95.19 ± 0.81 | 93.23 ± 1.43 |
| ESD (150/80) +ve | 95.43 ± 2.34 | 95.62 ± 0.34 | 94.24 ± 1.39 |
| Spray dried (180/90) | 98.13 ± 1.20 | 85.89 ± 1.40 | 77.84 ± 0.96 |

The 5-hydroxymethylfurfural (HMF) content indicates Maillard browning reactions and is shown in Table 20. On Day 0, the HMF content was lowest (<27 μg/100 g) in ESD powders manufactured at the lowest temperature (90° C. inlet and 35° C. outlet). At the higher ESD temperature (150° C. inlet and 80° C. exhaust), the high processing temperature accelerated Maillard reactions, and the HMF values increased to approximately 53 μg/100 g (−ve ESD) and 54 μg/100 g (+ve ESD). The HMF content also was higher (107 μg/100 g) in spray dried powders (180° C. inlet/90° C. exhaust) compared to the ESD sample dried at 90° C.

TABLE 20

| | HMF Content (μg/100 g sample) | | |
|---|---|---|---|
| | | 22° C. and | 45° C. and |
| | | 11% RH | 54% RH |
| | Day 0 | Week 8 | Week 2 |
| ESD (90/35) −ve | 26.73 ± 4.04 | 30.93 ± 1.70 | 115.77 ± 5.10 |
| ESD (150/80) −ve | 52.94 ± 3.22 | 59.56 ± 1.89 | 196.84 ± 3.67 |
| ESD (90/35) +ve | 25.93 ± 3.05 | 24.46 ± 1.95 | 125.00 ± 3.23 |
| ESD (150/80) +ve | 53.73 ± 3.37 | 52.53 ± 3.31 | 150.87 ± 6.93 |
| Spray dried (180/90) | 37.01 ± 5.00 | 49.06 ± 0.83 | 152.55 ± 7.16 |
| Powder | Free flowing | Free flowing | Caked |
| Characteristics | | | |

The HMF content generally increased in powders during controlled storage. Storage for eight weeks at 22° C. and 11% relative humidity (RH) increased the HMF content in ESD powders manufactured at the lowest temperature (90° C. inlet and 35° C. outlet) to 31 μg/100 g (−ve ESD) and remained unchanged in +ve ESD powders. The HMF content increased to 60 μg/100 g (−ve ESD) and remained unchanged in +ve ESD powders dried at higher temperature (150° C. inlet and 90° C. exhaust). The HMF content increase to 103 μg/100 g in spray dried powders (180° C. inlet/90° C. exhaust).

Storage for two weeks at 45° C. and 54% relative humidity (RH) increased the HMF content in ESD powders manufactured at the lowest temperature (90° C. inlet and 35° C. outlet) to 115 μg/100 g (−ve ESD) and 125 μg/100 g in +ve ESD powders. The HMF content increased to 197 μg/100 g (−ve ESD) and 151 μg/100 g in +ve ESD powders dried at higher temperature (150° C. inlet and 90° C. exhaust). The HMF content increased to 153 μg/100 g in spray dried powders (180° C. inlet/90° C. exhaust).

### Example 11

This example demonstrates the low temperature electrostatic spray drying of skim milk powder (SMP) in an embodiment of the invention.

Skim milk containing 40% solids (w/w) was dried with an ESD at the operating conditions specified in Table 21. Skim milk was also spray dried by conventional high heat spray drying for comparison at similar conditions to those reported in the literature (see, e.g., S. Padma Ishwarya and C. Anandharamakrishnan, “Spray Drying” in Handbook of Drying for Dairy Products, 1st Ed., John Wiley & Sons, 2017, pages 57-94; Bloore & O'Callaghan, “Process Control in Evaporation and Drying” in Dairy Powders and Concentrated Products, Wiley-Blackwell, 2009, pages 332-350; and Kelly et al., “Manufacture and Properties of Milk Powders” in Advanced Dairy Chemistry Volume 1: Proteins, 3rd Ed., Kluwer Academic/Plenum Publishers, 2003, pages 1027-1061).

TABLE 21

| | | | Spray |
|---|---|---|---|
| | ESD | ESD | Dried |
| Parameter | (90/35) | (150/80) | (180/90) |
| Inlet temp (° C.) | 90 | 150 | 180 |
| Atomizing temp (° C.) | 35 | 80 | 90 |
| Atomizing gas pressure (kPa) | 240 | 340 | 300 |
| PWM voltage (High/Low) (kV) | 10/1 | NA | NA |
| Continuous voltage (kV) | NA | 0.9 | NA |
| Charge | −ve and | −ve and | NA |
| | +ve | +ve | |

NA: not applicable

SMP was made by electrostatic spray drying at inlet temperatures of 90° C. and 150° C., however, the inlet drying temperature can be as low as 80° C. Atomizing and exhaust temperatures are generally maintained below 60° C., and in this example, atomizing and exhaust temperatures were set to 35° C. and 80° C. Atomizing gas pressure can range from 30-552 kPa. Negative and positive pulsed width modulation (PWM) alternating between 10 kV and 1 kV was used when drying at 90/35° C. and a 0.9 kV continuous voltage when drying at 150/80° C. Electrostatic charge can be, for example, as low as 0.1 kV and as high as 15 kV and either with or without PWM. For comparison, SMP was also spray dried at 180/90° C. by conventional high heat spray drying.

The typical moisture content and water activity for electrostatic spray dried SMP is below 4% moisture and a water activity of 0.2. In this example, the powder properties are shown in Table 22. At a 90° C. inlet drying temperature, the moisture content of SMP was below 3.68%, and the water activity was below 0.1203. Electrostatic spray drying at 150° C. produced powders with both a lower moisture content and water activity (1.77% moisture and below; a water activity of 0.0605 and below). In comparison, traditional high heat spray dried powder had a moisture content and water activity of 2.48% and 0.1830, respectively.

TABLE 22

| | Moisture (%) | Water Activity |
|---|---|---|
| ESD (90/35) −ve | 3.37 ± 0.18 | 0.1063 ± 0.0156 |
| ESD (150/80) −ve | 1.70 ± 0.39 | 0.0438 ± 0.0115 |
| ESD (90/35) +ve | 3.68 ± 0.12 | 0.1231 ± 0.0048 |
| ESD (150/80) +ve | 1.77 ± 0.08 | 0.0605 ± 0.0071 |
| Spray dried (180/90) | 2.48 ± 0.13 | 0.1830 ± 0.0050 |

The average particle size of SMP reported as D[4,3] values is shown in Table 23. Electrostatic spray drying at a 150° C. inlet temperature produced powders with an average particle size of approximately 12 μm (−ve ESD) and 17 μm (+ve ESD). ESD powders dried at the milder inlet temperature of 90° C. had larger particle sizes of 54 μm (−ve ESD) and 32 μm (+ve ESD). Spray drying at an inlet temperature of 180° C. produced powders with an average particle size of approximately 38 μm and much closer resembling the particle size of ESD powders dried at the lower temperature (90° C.).

TABLE 23

| | Particle Size (μm) |
|---|---|
| ESD (90/35) −ve | 54.45 ± 0.25 |
| ESD (150/80) −ve | 11.90 ± 0.06 |
| ESD (90/35) +ve | 32.25 ± 0.22 |
| ESD (150/80) +ve | 17.30 ± 0.25 |
| Spray dried (180/90) | 38.30 ± 0.42 |

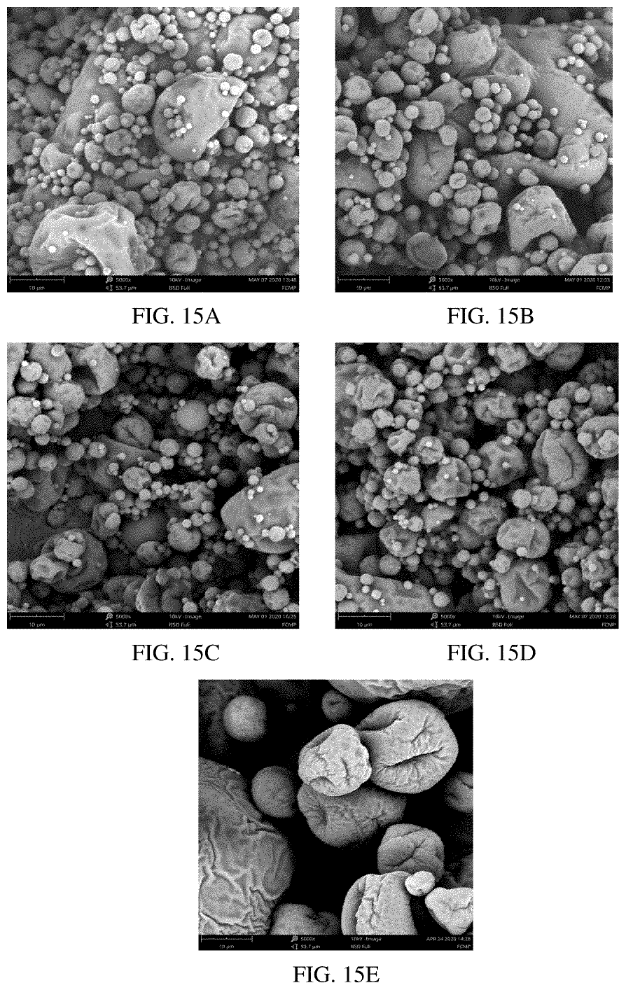

FIG. 15 is a series of SEM images at 2000× magnification for SMP powders dried at 90/35° C. (negative charge in FIG. 15A and positive charge in FIG. 15B), ESD powders dried at 150/80° C. (negative charge in FIG. 15C and positive charge in FIG. 15D), and the spray dried SMP powder (FIG. 15E). As seen in the images, the ESD powders were agglomerated, and the primary particles were predominantly spherical in appearance. The spray dried primary particles also were spherical but larger than the ESD powders. The surface of the SMP powders showed depressions, and these features become more dominant in spray dried powders. These depressions and shriveled-like appearance are typical of spray dried low-fat dairy powders dried at low temperatures. See, e.g., Nijdam et al., Journal of Food Engineering, 77, 919-925 (2005).

The solubility of SMP powders in water at 22±2° C. is shown in Table 24. Despite the significant differences in drying temperatures between ESD and traditional high heat spray drying, all powders had high solubility exceeding 98%.

TABLE 24

| | Solubility (%) |
|---|---|
| ESD (90/35) −ve | 98.74 ± 0.25 |
| ESD (150/80) −ve | 98.81 ± 0.06 |
| ESD (90/35) +ve | 98.88 ± 0.22 |
| ESD (150/80) +ve | 98.78 ± 0.25 |
| Spray dried (180/90) | 98.51 ± 0.05 |

Table 25 shows the glass transition temperature (T_{g}) for ESD and spray dried SMP. Spray drying at an inlet temperature of 180° C. and electrostatic spray drying at a 150° C. inlet temperature produced powders with higher T_{g} compared to ESD powders dried at the milder inlet temperature of 90° C. Drying at the higher temperatures (>150° C.) is likely to contribute to whey protein denaturation and together with the lower moisture content accounts for the higher T_{g}. Drying at the milder ESD temperature is likely to avoid whey protein denaturation and together with the higher moisture content accounts for the lower T_{g}.

TABLE 25

| | T_{g} (° C.) |
|---|---|
| ESD (90/35) −ve | 42.34 ± 8.05 |
| ESD (150/80) −ve | 71.63 ± 5.23 |
| ESD (90/35) +ve | 39.88 ± 3.24 |
| ESD (150/80) +ve | 68.52 ± 6.34 |
| Spray dried (180/90) | 56.24 ± 1.75 |

The 5-hydroxymethylfurfural (HMF) content in SMP is an indicator of Maillard browning and shown in Table 26. The HMF content was lowest (approximately 25 μg/100 g) in ESD powders manufactured at the lowest temperature (90° C. inlet and 35° C. exhaust). At the higher ESD temperature (150° C. inlet and 60° C. exhaust), the high processing temperature accelerated the Maillard reactions, and the HMF values increased to approximately 53 μg/100 g (−ve ESD) and 56 μg/100 g (+ve ESD). Spray dried full cream milk powders dried at highest temperature of 180° C. inlet and 90° C. exhaust had the highest HMF values reaching approximately 83 μg/100 g.

TABLE 26

| Fresh powder | HMF (μg/100 g sample) |
|---|---|
| ESD (90/35) −ve | 25.66 ± 2.52 |
| ESD (150/80) −ve | 52.70 ± 6.55 |
| ESD (90/35) +ve | 24.56 ± 6.16 |
| ESD (150/80) +ve | 56.11 ± 4.28 |
| Spray dried (180/90) | 83.39 ± 8.24 |

### Example 12

This example demonstrates the low temperature electrostatic spray drying of full cream powder in an embodiment of the invention.

Full cream milk containing 40% solids (w/w) was dried with an ESD at the operating conditions specified in Table 27. Skim milk was also spray dried by conventional high heat spray drying for comparison at similar conditions to those reported in literature (see, e.g., S. Padma Ishwarya and C. Anandharamakrishnan, “Spray Drying” in Handbook of Drying for Dairy Products, 1st Ed., John Wiley & Sons, 2017, pages 57-94; Bloore & O'Callaghan, “Process Control in Evaporation and Drying” in Dairy Powders and Concentrated Products, Wiley-Blackwell, 2009, pages 332-350; and Kelly et al., “Manufacture and Properties of Milk Powders” in Advanced Dairy Chemistry Volume 1: Proteins, 3rd Ed., Kluwer Academic/Plenum Publishers, 2003, pages 1027-1061).

TABLE 27

| | | | Spray |
|---|---|---|---|
| | ESD | ESD | Dried |
| Parameter | (90/35) | (150/80) | (180/90) |
| Inlet temp (° C.) | 90 | 150 | 180 |
| Atomizing temp (° C.) | 35 | 80 | 90 |
| Atomizing gas pressure (kPa) | 240 | 340 | 300 |
| PWM voltage (High/Low) (kV) | 10/1 | NA | NA |
| Continuous voltage (kV) | NA | 0.9 | NA |
| Charge | −ve and | −ve and | NA |
| | +ve | +ve | |

NA: not applicable

Full cream milk powder was made by electrostatic spray drying at inlet temperatures of 90° C. and 150° C., however, the inlet drying temperature can be as low as 80° C. Atomizing and exhaust temperatures are generally maintained below 60° C., and in this example, the atomizing and exhaust temperatures were set to 35° C. and 80° C. Atomizing gas pressure can range from 30-552 kPa. Negative and positive pulsed width modulation (PWM) alternating between 10 kV and 1 kV was used when drying at 90/35° C. and a 0.9 kV continuous voltage was used when drying at 150/80° C. The electrostatic charge can be as low as 0.1 kV and as high as 15 kV and with or without PWM. For comparison, milk powder was also spray dried at 180/90° C. by conventional high heat spray drying.

Electrostatic spray dried milk powder typically has a moisture content below 4% and a water activity of 0.2. In this example, the powder properties are shown in Table 28. At a 90° C. inlet drying temperature, the moisture content was 3.16% and below, and the water activity was 0.083 and below. Electrostatic spray drying at 150° C. produced powders with both a lower moisture content and water activity (2.11% and below moisture content; and water activity of 0.053 and below). In comparison, the traditional high heat spray dried powder had a moisture content of 1.85% and a water activity of 0.074.

TABLE 28

| | Moisture (%) | Water Activity |
|---|---|---|
| ESD (90/35) −ve° | 3.16 ± 0.31 | 0.083 ± 0.022 |
| ESD (150/80) −ve | 1.77 ± 0.33 | 0.053 ± 0.017 |
| ESD (90/35) +ve | 2.47 ± 0.35 | 0.071 ± 0.004 |
| ESD (150/80) +ve | 2.11 ± 0.29 | 0.053 ± 0.006 |
| Spray dried (180/90) | 1.85 ± 0.08 | 0.074 ± 0.014 |

The average particle sizes of dried full cream milk powders reported as D[4,3] values are shown in Table 29. Electrostatic spray drying at a 150° C. inlet temperature produced powders with an average particle size of approximately 17 μm (−ve ESD) and 15 μm (+ve ESD). ESD powders dried at the milder inlet temperature of 90° C. had larger particle sizes of 37 μm (−ve ESD) and 49 μm (+ve ESD). Spray drying at an inlet temperature of 180° C. produced powders with an average particle size of approximately 34 μm, which is lower than the particle size of ESD powders dried at the lower temperature (90° C.).

TABLE 29

| | Particle size (μm) |
|---|---|
| ESD (90/35) −ve | 37.27 ± 3.87 |
| ESD (150/80) −ve | 17.43 ± 3.70 |
| ESD (90/35) +ve | 48.98 ± 10.13 |
| ESD (150/80) +ve | 14.93 ± 1.00 |
| Spray dried (180/90) | 34.27 ± 9.33 |

The solubility of electrostatic spray dried and spray dried full cream milk powders in water at 22±2° C. is shown in Table 30. Despite the significant differences in drying temperatures between ESD and traditional high heat spray drying, all the dried powders had high solubility exceeding 95%.

TABLE 30

| | Solubility (%) |
|---|---|
| ESD (90/35) −ve | 96.89 ± 0.90 |
| ESD (150/80) −ve | 95.82 ± 0.93 |
| ESD (90/35) +ve | 97.41 ± 1.50 |
| ESD (150/80) +ve | 97.35 ± 0.70 |
| Spray dried (180/90) | 96.88 ± 1.77 |

Table 31 shows the glass transition temperature (T_{g}) for ESD and spray dried milk powders. Spray drying at an inlet temperature of 180° C. and electrostatic spray drying at a 150° C. inlet temperature produced powders with higher T_{g} compared to ESD powders dried at the milder inlet temperature of 90° C. Drying at the higher temperatures (>150° C.) is likely to contribute to whey protein denaturation and together with the lower moisture content accounts for the higher T_{g}. Drying at the milder ESD temperature is likely to avoid whey protein denaturation and together with the higher moisture content accounts for the lower T_{g}.

TABLE 31

| | T_{g} (° C.) |
|---|---|
| ESD (90/35) −ve | 48.22 ± 1.15 |
| ESD (150/80) −ve | 74.46 ± 0.07 |
| ESD (90/35) +ve | 49.97 ± 1.74 |
| ESD (150/80) +ve | 69.39 ± 1.97 |
| Spray dried (180/90) | 66.05 ± 1.01 |

Table 32 shows the oxidative stability of spray dried and electrostatic spray dried full cream milk powders. Oxidation immediately after manufacture (Day 0) was generally lower in ESD powders than in spray dried powders. After storage under controlled conditions (45° C. and 11% relative humidity (RH)), oxidation increased in all powders. However, the greatest increase was measured in spray dried powders: increasing from approximately 45 μg O₂/kg oil to 78 μg O₂/kg oil after 4 weeks of storage and 145 μg O₂/kg oil after 6 weeks. Oxidation also increased in ESD powders but remained below 90 μg O₂/kg oil.

TABLE 32

| | | Storage at 45 °C and | |
|---|---|---|---|
| | | 11% RH | |
| | Oxidation | Oxidation | Oxidation |
| | (μg O₂/kg | (μg O₂/kg | (μg O₂/kg |
| | oil) | oil) | oil) |
| | Day 0 | Week 4 | Week 6 |
| ESD (90/35) −ve | 43.49 ± 3.72 | 47.23 ± 2.34 | 90.39 ± 1.64 |
| ESD (150/80) −ve | 35.51 ± 0.93 | 45.47 ± 2.37 | 81.12 ± 1.02 |
| ESD (90/35) +ve | 37.41 ± 0.23 | 49.95 ± 2.80 | 71.80 ± 1.39 |
| ESD (150/80) +ve | 28.18 ± 0.81 | 50.14 ± 0.95 | 80.24 ± 2.84 |
| Spray dried | 44.92 ± 2.04 | 77.74 ± 2.21 | 145.02 ± 0.23 |
| (180/90) | | | |
| Powder | Free flowing | Free flowing | Free flowing |
| Characteristics | | | |

The 5-hydroxymethylfurfural (HMF) content is measured as μg/100 g sample and is an indicator of Maillard browning reactions and is shown in Table 33.

TABLE 33

| | HMF Content (μg/100 g sample) | | |
|---|---|---|---|
| | | Storage at 22° C. and | |
| | | 54% RH | |
| | Day 0 | Week 1 | Week 2 |
| ESD (90/35) −ve | 74.10 ± 5.95 | 95.49 ± 0.62 | 104.23 ± 6.53 |
| ESD (150/80) −ve | 92.82 ± 5.63 | 102.86 ± 1.76 | 155.37 ± 5.17 |
| ESD (90/35) +ve | 77.22 ± 7.06 | 82.33 ± 4.61 | 90.60 ± 1.17 |
| ESD (150/80) +ve | 101.14 ± 2.48 | 100.87 ± 6.48 | 105.88 ± 9.07 |
| Spray dried | 107.00 ± 6.02 | 124.30 ± 7.03 | 403.07 ± 8.29 |
| (180/90) | | | |
| Powder | Free flowing | Free flowing | Free flowing |
| Characteristics | | | |

On Day 0, the HMF content was the lowest (<77 μg/100 g) in ESD powders manufactured at the lowest temperature (90° C. inlet and 35° C. outlet). At the higher ESD temperature (150° C. inlet and 80° C. exhaust), the higher processing temperature accelerated Maillard reactions, and the HMF values increased to approximately 93 μg/100 g (−ve ESD) and 101 μg/100 g (+ve ESD). HMF was greater again (107 μg/100 g) in spray dried powders produced at 180° C. inlet/90° C. exhaust.

HMF increased in all powders during controlled storage (22° C. and 54% relative humidity (RH)). After 1 week, the HMF content in ESD powders manufactured at the lowest temperature (90° C. inlet and 35° C. outlet) increased to 95 μg/100 g (−ve ESD) and 82 μg/100 g (+ve ESD). After 2 weeks, the HMF was 104 μg/100 g (−ve ESD) and 91 μg/100 g (+ve ESD).

Substantially higher HMF values were recorded in ESD powders dried at higher temperature (150° C. inlet and 80° C. exhaust). After 1 week, HMF increased to 103 μg/100 g (−ve ESD) and 101 μg/100 g (+ve ESD). After 2 weeks, the HMF was 155 μg/100 g (−ve ESD) and 105 μg/100 g (+ve ESD).

Spray dried full cream milk powders dried at 180° C. inlet and 90° C. exhaust had the highest HMF values reaching 124 μg/100 g after 1 week and 403 μg/100 g after 2 weeks. The color changed from white to brown in spray dried whole milk powder that occurred during HMF analysis after two weeks of storage at 22° C. and 54% RH.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrostatic spray dried powdered milk product with a surface composition comprising at least 8% less fat compared to a spray dried powder of the same milk product.

2. The electrostatic spray dried powdered milk product of claim 1, wherein about 10% or more of the surface composition comprises a carbohydrate.

3. The electrostatic spray dried powdered milk product of claim 1 or claim 2, wherein the powdered milk product is agglomerated.

4. The electrostatic spray dried powdered milk product of claim 3, wherein the agglomerate size is 100 μm or more.

5. The electrostatic spray dried powdered milk product of any one of claims 1-4, wherein the milk product comprises milk, butter, manufacturer's cream, heavy whipping cream, whipping cream, medium cream, light cream, half and half, buttermilk, yogurt, a nutritional formulation, colostrum, whey proteins, lactoferrin, lactoglobulin, or any combination thereof.

6. The electrostatic spray dried powdered milk product of any one of claims 1-5, wherein the milk product comprises colostrum.

7. The electrostatic spray dried powdered milk product of any one of claims 1-6, wherein the milk product has a fat content of about 3-6%.

8. The powdered milk product of any one of claims 1-7, wherein the powdered milk product is electrostatically spray dried at an inlet temperature of below 150° C.

9. The electrostatic spray dried powdered milk product of claim 8, wherein the applied voltage is about 0.1 kV or more.

10. A method of providing a powdered milk product comprising electrostatic spray drying a milk product at an inlet temperature of below 150° C.

11. The method of claim 10, wherein the atomizing temperature is about 80° C. or below.

12. The method of claim 10 or claim 11, wherein the applied voltage is about 0.1 kV or more.

13. The method of any one of claims 10-12, wherein the applied voltage is continuous.

14. The method of any one of claims 10-13, wherein the applied voltage is modulated between two or more different voltages.

15. The method of any one of claims 10-14, wherein the applied voltage alternates charges.

16. The method of any one of claims 10-15, wherein the powdered milk product has a surface composition comprising at least 8% less fat compared to a spray dried powder of the same milk product.

17. The method of any one of claims 10-16, wherein the powdered milk product has a surface composition comprising about 10% or more of a carbohydrate.

18. The method of any one of claims 10-17, wherein the powdered milk product is agglomerated during the electrostatic spray process.

19. The method of claim 18, wherein the agglomerate size is 100 μm or more.

20. The method of any one of claims 10-19, wherein the milk product comprises cream, heavy whipping cream, whipping cream, medium cream, light cream, half and half, buttermilk, yogurt, a nutritional formulation, colostrum, whey proteins, lactoferrin, lactoglobulin, or any combination thereof.

21. The method of any one of claims 10-20, wherein the milk product comprises colostrum.

22. The method of any one of claims 10-21, wherein the milk product has a fat content of about 3-6%.
